(19) United States
(12) Patent Application Publication
(10) Pub. No.: US 2024/0211299 A1
(43) Pub. Date: Jun. 27, 2024

(54) TECHNIQUE FOR HANDLING REQUEST TRANSFERS FROM A PERIPHERAL DEVICE IN A COMMUNICATION NETWORK

(71) Applicant: Arm Limited, Cambridge (GB)

(72) Inventors: Matthew Lucien Evans, Cambridge (GB); Robert Gwilym Dimond, Cambridge (GB)

(73) Assignee: Arm Limited, Cambridge (GB)

(21) Appl. No.: 18/555,041

(22) PCT Filed: Mar. 24, 2022
(86) PCT No.: PCT/GB2022/050738

§ 371 Date: Oct. 12, 2023

(30) Foreign Application Priority Data
May 10, 2021 (GB) 2106624.6

(51) Int. Cl. G06F 9/455; G06F 9/48

(52) U.S. Cl. CPC G06F 9/45558; G06F 9/4856; G06F 2009/45579; G06F 2009/45583

(57) ABSTRACT

A host device (10) provides a plurality of virtual machines (54) executing one or more processes (60, 62, 64, 66). A peripheral device (30) performs tasks on behalf of the host and is coupled to it via a communication network (20). The peripheral provides a plurality of virtual peripheral devices (34), each allocated to one of the virtual machines. Address translation circuitry (75) in the host performs two-stage address translation. When accessing a memory (40) via the host, the peripheral requests a transfer with a specified address and associated metadata providing a source identifier field, a first address translation control field and a second address translation control field. The first address translation control field controls any first stage address translation and depends on the process. The second address translation control field controls any second stage address translation required and depends on the virtual machine associated with the specified address.

### BACKGROUND

Described herein is a technique for handling request transfers from a peripheral device in a communication network.

In modern data processing systems, it is now possible for a peripheral device to be configured so as to present multiple virtual peripheral devices that can be used by a host device coupled to that peripheral device via a communication network. Such an approach can be useful, for example, where the host device provides a plurality of virtual machines, where each virtual machine is arranged to execute one or more processes. In such a situation, the peripheral device can be used to perform tasks on behalf of the processes executed on the host device, and each virtual peripheral device made available by that peripheral device may then be allocated to one of the virtual machines.

Within a host device that employs virtual machines, then virtual addresses are often used when accessing memory, and address translation circuitry is used to translate the virtual addresses into corresponding physical addresses within the memory system. The peripheral device may need to access memory in order to perform tasks on behalf of the host device and it is hence important when issuing requests from the peripheral device to provide information that will enable an appropriate address translation to be performed taking into account the virtual machine associated with the virtual peripheral device making that request. It is also necessary for the request to include sufficient information to enable any response to that request to be routed back to the correct peripheral device.

As the number of virtual peripheral devices that may be provided by a peripheral device increase, then these issues can give rise to scalability problems.

### SUMMARY

In one example arrangement, there is provided an apparatus comprising: a host device coupled to a memory system and arranged to provide a plurality of virtual machines, where each virtual machine is arranged to execute one or more processes; a peripheral device arranged to perform tasks on behalf of the processes executed on the host device, and coupled to the host device via a communication network, wherein the peripheral device is configurable as a plurality of virtual peripheral devices, where each virtual peripheral device is allocated to one of the virtual machines; and address translation circuitry associated with the host device and arranged to perform an address translation to translate a given address into a corresponding physical address within the memory system, when the given address is a virtual address the address translation comprising a first stage address translation that is dependent on the process associated with the given address, and the address translation further comprising a second stage address translation that is dependent on the virtual machine associated with the given address; wherein: the peripheral device is arranged, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

In another example arrangement, there is provided a method of handling request transfers in a communication network, comprising: providing a plurality of virtual machines within a host device coupled to a memory system, where each virtual machine is arranged to execute one or more processes; employing a peripheral device to perform tasks on behalf of the processes executed on the host device, wherein the peripheral device is configurable as a plurality of virtual peripheral devices, where each virtual peripheral device is allocated to one of the virtual machines; coupling the peripheral device to the host device via the communication network; employing address translation circuitry associated with the host device to perform an address translation to translate a given address into a corresponding physical address within the memory system, when the given address is a virtual address the address translation comprising a first stage address translation that is dependent on the process associated with the given address, and the address translation further comprising a second stage address translation that is dependent on the virtual machine associated with the given address; and causing the peripheral device, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

In a still further example arrangement, there is provided a host device comprising: a processing element arranged to provide a plurality of virtual machines, where each virtual machine is arranged to execute one or more processes; a bridging component to communicate, via a communication network, with a peripheral device arranged to perform tasks on behalf of the processes executed on the host device, wherein the peripheral device is configurable as a plurality of virtual peripheral devices, where each virtual peripheral device is allocated to one of the virtual machines; and address translation circuitry arranged to perform an address translation to translate a given address into a corresponding physical address within a memory system accessible via the host device, when the given address is a virtual address the address translation comprising a first stage address translation that is dependent on the process associated with the given address, and the address translation further comprising a second stage address translation that is dependent on the virtual machine associated with the given address; wherein: the address translation circuitry is arranged to receive a request transfer via the bridging component from the peripheral device when the peripheral device is seeking to access the memory system, the request transfer having a specified address and having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

In a yet further example arrangement, there is provided a peripheral device comprising: an interface to a communication network via which the peripheral device is arranged to communicate with a host device that is coupled to a memory system, the host device providing a plurality of virtual machines, where each virtual machine is arranged to execute one or more processes; and circuitry to perform tasks on behalf of the processes executed on the host device, wherein the circuitry of the peripheral device is configurable to provide a plurality of virtual peripheral devices, where each virtual peripheral device is allocated to one of the virtual machines; wherein: the peripheral device is arranged, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by address translation circuitry of the host device to control any first stage address translation required for the specified address when the specified address is a virtual address, the first stage address translation being dependent on the process associated with the specified address, and the second address translation control field provides a virtual machine indication used by the address translation circuitry to control any second stage address translation required for the specified address, the second stage address translation being dependent on the virtual machine associated with the specified address.

### BRIEF DESCRIPTION OF THE DRAWINGS

The present technique will be described further, by way of illustration only, with reference to examples thereof as illustrated in the accompanying drawings, in which:

FIG. 1 is a block diagram of a system in which the techniques described herein may be utilised;

FIG. 2A schematically illustrates a system in which the present technique may be utilised, and provides more detail of the structure of packets and associated metadata that may be transferred between a peripheral device and a host device in accordance with one example implementation;

FIG. 2B schematically illustrates how the information provided within a packet and associated metadata may be used by address translation circuitry to control the performance of an address translation process, in accordance with one example implementation;

FIG. 2C schematically illustrates a two stage address translation process;

FIGS. 3A to 3C illustrate different example formats of packet and associated metadata that may be used in accordance with the techniques described herein;

FIG. 4 illustrates an example implementation where a subset of bits within a requester ID field are combined with the bits of an Extended Function ID field in order to determine an associated virtual machine for the request, with that information then being used to control a second stage address translation performed by the address translation circuitry;

FIG. 5 is a flow diagram illustrating steps performed in order to implement the techniques described herein, in accordance with one example implementation; and

FIG. 6 is a flow diagram illustrating in more detail the performance of step 370 of FIG. 5 by address translation circuitry, in accordance with one example implementation.

### DESCRIPTION OF EXAMPLES

In accordance with the techniques described herein, an apparatus is provided that has a host device coupled to a memory system, with the host device being arranged to provide a plurality of virtual machines, where each virtual machine is arranged to execute one or more processes. The apparatus also provides a peripheral device that is arranged to perform tasks on behalf of the processes executed on the host device, and which is coupled to the host device via a communication network. The peripheral device is configurable as a plurality of virtual peripheral devices, where each virtual peripheral device is allocated to one of the virtual machines. Such an approach can improve performance, since it allows the virtual peripheral device to be directly accessed by a virtual machine running on the host device.

The apparatus further provides address translation circuitry that is associated with the host device and which is arranged to perform an address translation to translate a given address into a corresponding physical address within the memory system. The address translation circuitry can take a variety of forms, and hence for example may be a separate component to the host device, or in some implementations may be an integrated component within the host device. The address translation performed by the address translation circuitry depends on the form of the given address, for example whether that address is a virtual address or an intermediate physical address. However, when the given address is a virtual address, the address translation comprises a first stage address translation that is dependent on the process associated with the given address. The address translation further comprises a second stage address translation that is dependent on the virtual machine associated with the given address, the second stage address translation being used both when the given address is a virtual address and when the given address is an intermediate physical address.

Since the peripheral device is performing tasks on behalf of the processes executed on the host device, then the peripheral device may need to issue request transfers seeking to access the memory system. In such a situation, the request transfer issued by the peripheral device will have a specified address and some associated metadata. As noted earlier, as the number of virtual peripheral devices supported by any one actual peripheral device increase, then scalability issues can arise. In particular it is important to provide a mechanism that will enable both efficient routing of a request transfer and any associated response transfer(s) through the communication network interconnecting the peripheral device with the host device, whilst also efficiently allowing the address translation circuitry to determine how to translate the specified address of that request transfer into a corresponding physical address, taking into account the virtual machine that the virtual peripheral device issuing the request transfer is allocated to.

In accordance with the techniques described herein, the associated metadata provided with a request transfer provides as separate fields a source identifier field, a first address translation control field and a second address translation control field. The source identifier field provides a source indication used to control routing of an associated response transfer over the communication network to the peripheral device. The first address translation control field provides a process indication used by the address translation circuitry to control any first stage address translation required for the specified address. Further, the second address translation control field provides a virtual machine indication (which may also be referred to as a virtual machine-selecting identifier) used by the address translation circuitry to control any second stage address translation required for the specified address.

Such an approach alleviates the earlier-mentioned scalability issue by decoupling the information used to control routing of an associated response transfer over the communication network from the information that is used to control the second stage address translation. In particular, this information may previously have been provided by a single source identifier field, with that single field in effect seeking to identify the virtual peripheral device issuing the request. Such information can be used to control the routing of the response transfer, and to provide information about the second stage address translation, since by identifying the virtual peripheral device it can then be determined which virtual machine has been allocated to it, and accordingly control the second stage address translation. However, the system allocation of the source identifier field may often mean that the number of possible values specifiable in the field is constrained, and that the field is inextensible. Hence as the number of virtual peripheral devices increases this can become problematic, and limit scalability.

However, by ensuring that separate fields are provided, it is possible to use the source identifier field to provide sufficient information to ensure correct routing of any associated response transfer for the request transfer, so that that response transfer is routed to the correct peripheral device, whilst using a separate field, namely the second address translation control field, to provide sufficient information to allow the address translation circuitry to perform the appropriate second stage address translation.

Furthermore, by providing a first address translation control field separate from the second address translation control field, the information to control any first stage address translation required can be kept entirely separate from the information used to control the second stage address translation, thus maintaining an effective partition between the information used to control the two stages of address translation and thereby improving security.

Hence, in summary, through use of the techniques described herein, a routing related identifier used to control the correct routing of any response transfer associated with a request transfer is kept separate from a virtual machine indication used to identify the virtual machine to which the virtual peripheral device issuing the request transfer has been allocated, with this latter information then being used by the address translation circuitry to control the second stage address translation. Further, the information controlling the first stage address translation is kept clear and distinct from the information controlling the second stage address translation, so as to maintain separation between that information, and thereby improve security.

It should be noted that because the second address translation control field is kept entirely separate to the source identifier field used to control routing, the second address translation control field can be ignored by those components within the communication network that do not need to reference that information. In one particular example implementation, the information within the second address translation control field may only be meaningful to the address translation circuitry, and to the peripheral device providing that information within its request transfer, and the information within the second address translation control field can be ignored by other intermediate components within the communication network. This has the benefit that no changes need to be made to those intermediate components.

The communication network can take a variety of forms, and hence for example could be an on-chip communication network such as an interconnect, or could be an off-chip communication network. In one example implementation the communication network is a packet network. In such an implementation, the request transfer then takes the form of a request packet, and the response transfer takes the form of a response packet. The metadata associated with the request packet may be provided within the request packet, or can be provided as separate information external to the request packet but associated therewith. Further, some parts of the metadata may be provided within the request packet whilst other parts of the metadata are provided externally to the request packet and associated therewith.

In such packet-based networks, adjustments to the format of the packets may be very restricted, and a particular field within a packet may have a restricted size in terms of the number of bits that can be used to specify that field. Hence, the above-mentioned scalability issues can be particularly problematic in such packet-based networks, in situations where more and more virtual peripheral devices are desired to be supported by a single physical peripheral device connected to the packet network.

There are a number of ways in which the second address translation control field may be provided in association with such a request packet. However, in one example the second address translation control field is provided as an external item of metadata that is provided separately to the request packet but associated with the request packet. This provides flexibility, as the second address translation control field is not provided as an internal field within the packet itself, but instead is provided via an external item of metadata that is associated with the packet. This hence avoids the difficulties that could be associated with trying to incorporate such information within a fundamental field of the existing packet structure supported by the packet network. The way in which this item of metadata is provided external to the packet, but associated therewith, could vary dependent on implementation, but could for example be provided as a prefix for the packet, or a suffix for the packet.

In one example implementation, the first address translation control field is provided as a further external item of metadata provided separately to the request packet but associated with the request packet, the further external item of metadata being distinct from the external item of metadata providing the second address translation control field. By providing such distinct items of metadata (for example as separate prefixes or suffixes) to provide the first address translation control field and the second address translation control field, this can provide a great deal of flexibility and the two fields can be managed independently. However, if desired, in an alternative implementation the first and second address translation control fields could be provided as distinct fields within a single external item of metadata. In this latter form of implementation, it should be noted that since the two address translation control fields are still provided as distinct fields, the earlier-mentioned isolation and security benefits associated with keeping the first stage and second stage address translation control information independent can still be achieved.

Whilst in the above example implementations the second address translation control field is provided as an external item of metadata associated with the request packet, rather than being contained within the request packet itself, in an alternative implementation the second address translation control field could be provided within a header portion of the request packet if desired.

The source identifier field can be provided in a variety of ways, but in one example implementation is provided within a header portion of the request packet. In one particular implementation, the source identifier field is a pre-existing field provided by the packet format of the packet network, and forms one of the fundamental fields provided within the packet. However, in accordance with the techniques described herein, the source identifier field is used for providing routing control information required to route an associated response transfer over the packet network to the peripheral device, and its function is not complicated by seeking to also provide information sufficient to control the second stage address translation. Instead, in accordance with the techniques described herein, a separate second address translation control field is used for that purpose.

The virtual machine indication can take a variety of forms. It could for example be used to identify directly the virtual machine to which the virtual peripheral device issuing the request transfer has been allocated. However, in one example implementation the virtual machine indication takes the form of a virtual peripheral device indication indicating the virtual peripheral device issuing the request transfer, and the address translation circuitry is arranged to determine, with reference to the virtual peripheral device indication, the virtual machine to which the virtual peripheral device issuing the request transfer is allocated.

The way in which the source indication is used can vary dependent on implementation. However, in one example implementation, for each request transfer issued by the peripheral device, the peripheral device is arranged to use the same source indication value to form the source indication used to control routing of the associated response transfer over the communication network to the peripheral device. Hence, in this example implementation, a single source indication value can be associated with the peripheral device, and used to control routing of the associated response transfer over the communication network to the peripheral device.

However, in some example implementations it may be beneficial to allow request transfers from the same peripheral device to have different source indication values. Hence, in one example implementation the peripheral device may have a range of source indication values, any one of which is useable to control routing of response transfers over the communication network to the peripheral device, and for each request transfer issued by the peripheral device, the peripheral device is arranged to select a source indication value from the range to be used as the source indication for that request transfer.

This may be useful in a variety of situations. For example, by allowing more than one source indication value to be used, this may allow the tracking of multiple outstanding requests by the peripheral device, which can give rise to performance benefits. Hence, in one example implementation the peripheral device may be arranged to track correspondence between outstanding request transfers and their associated response transfers though use of different source indication values for different request transfers.

In one example implementation, the source indication value used has no bearing on how the address translation circuitry determines the virtual machine associated with the virtual peripheral device issuing the request transfer. Instead, in such implementations the address translation circuitry may be arranged to determine the virtual machine associated with the virtual peripheral device issuing the request transfer directly from the virtual machine indication provided by the second address translation control field. Within such an implementation the virtual machine indication can take a variety of forms, but in one example implementation specifies a virtual machine number that is used to identify the virtual machine to the address translation circuitry.

However, if desired the address translation circuitry can be arranged to take into account other factors when determining the virtual machine based on the provided value of the virtual machine indication. For example, in one implementation the address translation circuitry may be arranged to determine the virtual machine associated with the virtual peripheral device issuing the request transfer with reference to both the virtual machine indication provided by the second address translation control field and the source indication value.

The manner in which the source indication value is used can vary dependent on implementation. For instance the way in which any particular value of virtual machine indication is interpreted may be dependent on the source indication value. By way of illustrative example, if the source indication value can be either 1 or 2, and there are four virtual machines A to D, the way in which the value of the virtual machine indication is mapped to a particular virtual machine may be dependent on the source indication value. For example, virtual machine indication values of 0 or 1 may be determined to correspond to virtual machines A and B, respectively, when the source indication value is 1, but those same values of virtual machine indication may instead be mapped to virtual machines B and C, respectively, if the source indication value is 2.

As another example of how the source indication value can be used to influence the determination of the virtual machine from the virtual machine indication, the address translation circuitry may be arranged to employ a subset of values of the source indication value, in combination with virtual machine indication, to determine the virtual machine associated with the virtual peripheral device issuing the request transfer. Hence, in this example, whilst the virtual machine indication provides part of the information required to identify the virtual machine, another part of the information required can be determined from the source indication value. Such an approach could, for example, allow the size of the second address translation control field to be reduced relative to an implementation where all of the required information to identify the virtual machine is instead provided within the second address translation control field. However, such an approach may constrain the flexibility in the way in which the bits of the source indication value could otherwise be used by the peripheral device.

The source indication information can also be used for other purposes, in addition to its primary purpose to control routing of an associated response transfer back to the peripheral device and/or the optional usage discussed earlier where the value of the source indication can be used to influence how the virtual machine is determined from the virtual machine indication. For example, the address translation circuitry may be arranged to reference the source indication to perform a permission check to determine whether the peripheral device is allowed to issue request transfers with the second address translation control field associated therewith. By such an approach, the use of the second address translation control field can be limited to use with certain peripheral devices.

As discussed earlier, the techniques described herein can be used in association with a wide variety of different communication networks, but one example use case is in association with a packet network. Such a packet network can take a variety of forms, but in one example implementation the packet network is a Peripheral Component Interconnect Express (PCIe) network, and the peripheral device is an endpoint device within the PCIe network.

Within such a PCIe network, the peripheral device could take a variety of forms. However, in one particular example implementation the peripheral device is a Single Root I/O Virtualisation (SR-IOV) device. An SR-IOV device is a particular form of device supported by an extension to the PCIe specification, that allows one physical device to present itself as multiple virtual peripheral devices for use by a host device. In PCIe terminology, the virtual peripheral devices may be referred to as virtual functions.

When considering a PCIe network, and implementations where the second address translation control field is provided as a prefix associated with the request packet, then that prefix may in one example implementation take the form of a transaction layer packet (TLP) prefix.

Furthermore, within such a PCIe network implementation, the source identifier field may be provided as a Requester ID field, also referred to herein as a RID field. Whereas previously the RID field may have been employed to provide a value that can be used for routing responses back to the relevant peripheral device, and also for controlling the second stage address translation by seeking to differentiate between traffic originating from each virtual function, in accordance with the techniques described herein the routing identifying information can be kept entirely separate from the information used to control the second stage address translation, with the RID field being used to capture the routing information. This can avoid the scalability issues discussed earlier when employing such SR-IOV devices within a PCIe network.

The peripheral devices can take a variety of forms. For example, they may take the form of an accelerator device that is used to perform a particular function on behalf of the host device. This form of peripheral device can be tailored to handle a specific task very efficiently, for example in a way that would be more efficient than using a general purpose CPU within the host device to perform such a task. Such accelerator devices can take a wide variety of different forms, for example a direct memory access (DMA) engine, an encryption device, etc. As another example form of peripheral device, the peripheral device may be an input/output (I/O) device, for example a network interface component used to transfer information into and out of the system.

Particular examples will now be described with reference to the figures.

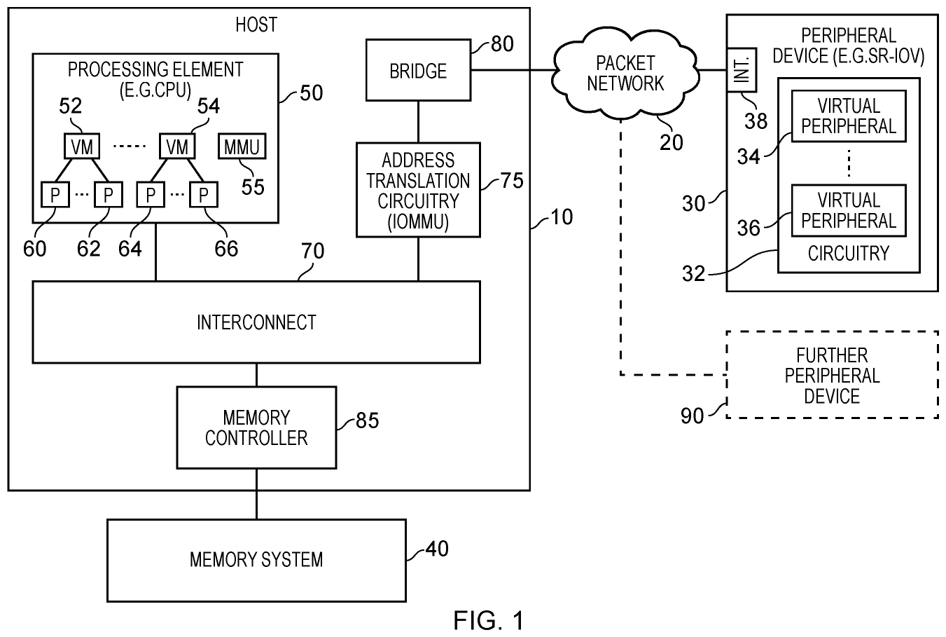

FIG. 1 is a block diagram of an example system in which the techniques described herein may be employed. As discussed earlier, the presently described technique can be used in association with a variety of different communication networks, but for the purposes of illustrative example the technique will be described with reference to the figures in the context of a packet network. More particularly, in the figures described herein, the packet network will be assumed to be a Peripheral Component Interconnect Express (PCIe) network where packets are transported over the packet network in accordance with the PCIe protocol.

As shown in FIG. 1, a host device 10 is connected to one or more peripheral devices 30, 90 via a packet network 20. In the simplest case, where the host device is connected to a single peripheral device, the packet network 20 may be implemented by a simple wire connection between the two devices, but in a more general case a more complex packet network may be provided including one or more layers of switches to route each packet from the transmitting entity of the packet to the intended recipient element for the packet.

The host device 10 includes a processing element 50, which may for example take the form of a central processing unit (CPU). The CPU is arranged to communicate with other components via an interconnect 70, and hence for example can access the memory system 40 via the interconnect 70, typically via a memory controller component 85 provided by the host device 10 to couple the host device to the memory system 40. A number of other elements may also be connected to the interconnect, with the processing element 50 being able to communicate with those elements via the interconnect. For the purposes of the present discussion, the example of FIG. 1 omits the detail of such other elements, other than a system memory management unit (SMMU) 75 and a bridge component 80. The SMMU 75, which may also be referred to as an input/output MMU (IOMMU) can be used by one or more of the components within the host device to perform address translations on behalf of that device. One such device that may use such an IOMMU is the bridge component 80 used to connect the host device 10 to the packet network 20. In the example use case of a PCIe network, such a bridge component is referred to as a root complex.

The processing element 50 is arranged to provide a plurality of virtual machines (VMs) 52, 54, and each VM may be arranged to execute one or more processes (Ps) 60, 62, 64, 66. Typically the processing element 50 will include its own address translation circuitry to perform translation of virtual or intermediate physical addresses generated by the processing element into corresponding physical addresses within the memory system 40. Hence, as shown in FIG. 1, the processing element 50 may be provided with a memory management unit (MMU) 55 for that purpose.

The peripheral devices 30, 90 may be used by the host device 10 to perform tasks on behalf of the processes executed on the host device 10. When performing such tasks, those peripheral devices may need to access the memory system 40, and hence may issue request packets via the packet network 20 for routing to the bridge component 80, and from there via the interconnect 70 to the memory system 40. Such request packets might include virtual addresses, and the IOMMU 75 will be used to perform the required address translation for the memory access requests specified by those request packets.

In systems employing virtual machines, it is often the case that a two stage address translation process is performed. In particular each VM 52, 54 may have its own operating system (OS) that can be used to control a first stage address translation process, in order to translate a specified virtual address into an intermediate physical address. By such an approach, the operating system can control the first stage translation in dependence on the particular process being executed. However, to ensure separation between the different virtual machines, a second stage address translation process can be used to convert the intermediate physical address produced by the first stage translation into an actual physical address within the memory system 40. Typically, the second stage translation is controlled by a hypervisor component (not shown in FIG. 1), the hypervisor being arranged to control the operation of the various virtual machines 52, 54. As will be understood by those skilled in the art, page tables within the memory system 40 may be accessed when performing such address translation in order to retrieve descriptors providing the necessary information to convert virtual addresses into intermediate physical addresses, and intermediate physical addresses into final physical addresses in memory, and descriptors retrieved from those page tables for that purpose may be locally cached within the address translation components, such as the MMU 55 or the IOMMU 75.

For access requests issued by the processing element 50, the associated MMU 55 may be used to perform the required two stage address translation process. Similarly, for requests initiated via the peripheral devices and routed via the bridge component 80, the IOMMU 75 may perform the required two stage address translation process.

As shown in FIG. 1, the peripheral device 30 has an interface 38 to the packet network 20 via which the peripheral device can communicate with the host device 10, and circuitry 32 for performing tasks on behalf of the processes executed on the host device 10. The circuitry 32 may be configurable to provide multiple virtual peripheral devices 34, 36, where each virtual peripheral device can be allocated to one of the virtual machines 52, 54. In the example implementation of a PCIe network, such a peripheral device that can provide multiple virtual peripheral devices may be referred to as a Single Root I/O Virtualisation (SR-IOV) device, and the virtual peripheral devices may be referred to as virtual functions.

In a typical PCIe network, a Requester ID (RID) is provided within each packet issued by a peripheral device, with that information being used to identify the peripheral device, and hence enable the packet network 20 to route any associated response packet back to the correct peripheral device once the request packet has been processed by the intended destination element. In the context of a peripheral device 30 providing multiple virtual peripheral devices, that RID has typically sought to further identify the particular virtual peripheral device 34, 36, or more particularly information enabling the virtual machine allocated to that particular virtual peripheral device to be determined by the IOMMU 75, so as to ensure the correct second stage address translation takes place, in dependence on the associated virtual machine. However, as systems become more complex, and hence for example the number of virtual machines and associated virtual peripheral devices increases, there is a scalability issue in seeking to provide this information within the existing RID field.

For example, a typical RID comprises bus and function portions. The RID is a fixed size value, 16 bits, of which 8 bits may be associated with the bus and 8 bits may be associated with the function. A physical peripheral device (also referred to as a physical endpoint) will be associated with a bus, and then the remaining function bits of the RID can be used to define virtual peripheral devices in accordance with the existing PCIe approach. Assuming an implementation where 8 bits are allocated to the bus and 8 bits are allocated to the function, this means that up to 256 functions can be identified by the RID for a particular bus. As the number of virtual peripheral devices seeking to be supported by a single SR-IOV endpoint increases, the use of a single bus may be insufficient, and hence for example a really large SR-IOV endpoint might occupy multiple bus numbers. For example, with 8192 virtual peripheral devices to be supported by such an endpoint device, 32 bus numbers may be used.

It should also be noted that any physical endpoint device will use at least one bus. This means for example that if a peripheral device just provides one virtual function, then the other 255 possible function values for the particular RID specifying that bus will be unused.

Against this background, it can be seen that a significant scaling challenge occurs as the number of virtual machines, and associated virtual peripheral devices, increases. In particular, in PCIe, the RID is a finite 16-bit namespace, and the 64,000 possible combinations of RID can become used quite quickly in such situations. For example, an SR-IOV endpoint with 10,000 to 20,000 virtual functions would consume a large portion of the namespace. If there are a few such endpoints in the system (for example providing different types of I/O or accelerator service) then it is clear that the 64,000 possible combinations in the RID namespace get divided down very quickly.

One change that might be considered would be to make the RID field larger. However, in PCIe this is a fundamental field to most packets, and such a change would be very disruptive. In particular, hosts, endpoints and intermediate components (for example switches) would all have to change to accommodate such an increased size in the RID field. As will be discussed herein, a technique has been developed that can address this scalability issue without needing to increase the size of the RID field.

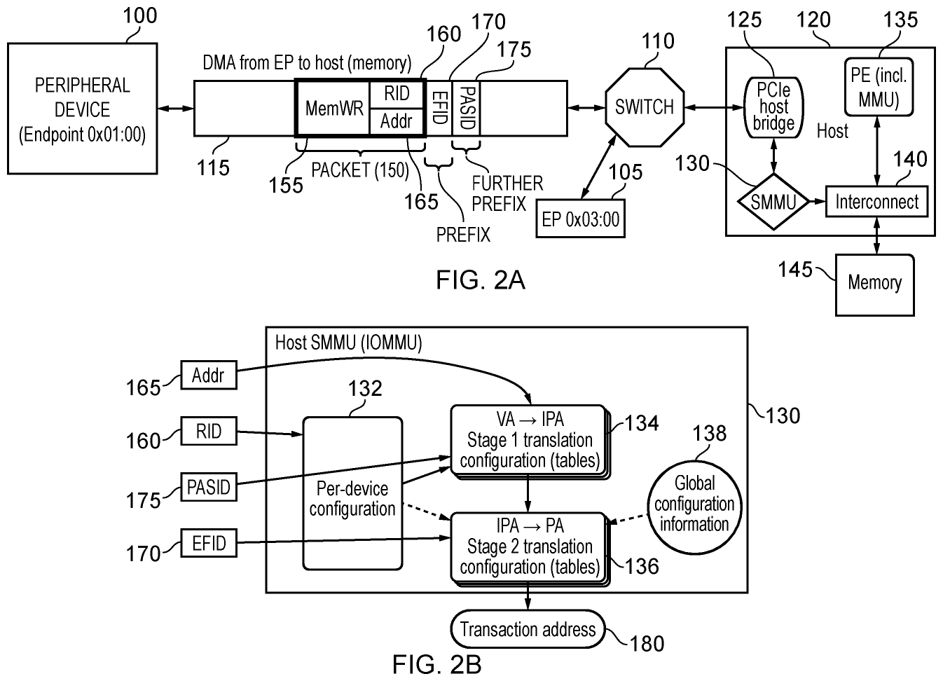

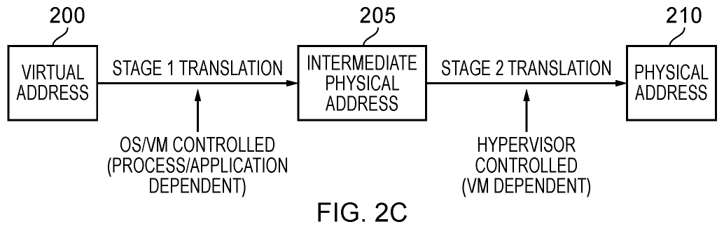

FIG. 2A illustrates a PCIe network including two peripheral devices 100, 105 coupled via a switch 110 to a host device 120. The host device 120 takes the form discussed earlier with reference to FIG. 1, and hence has a processing element 135 that may include its own MMU, coupled via an interconnect 140 to memory 145 (for simplicity of illustration the memory controller component is omitted in FIG. 2A). A PCIe host bridge component 125 is used to couple the host device 20 to the PCIe network, and an SMMU component 130 (also referred to herein as an IOMMU) is used to perform address translation in respect of requests to access memory 145 received from the PCIe network, for example from one of the peripheral devices 100, 105.

In this example, it is assumed that the peripheral device 100 is an SR-IOV peripheral device that can support the provision of multiple virtual peripheral devices (as mentioned earlier these also being referred to as virtual functions in PCIe terminology). The peripheral devices are also referred to as endpoint devices, and their requester ID (RID) value is shown by way of illustration in hexadecimal format in association with the devices 100, 105. In this example, the endpoint device 100 has a RID value whose bus portion identifies bus number 1, whilst the endpoint 105 has a RID value whose bus portion identifies the bus 3. In this example, the function portions of the RID are not used, and accordingly are set to “00”.

In FIG. 2A, it is assumed that the peripheral device 100 performs direct memory access (DMA) tasks on behalf of the host, and this results in the generation of DMA traffic passing over the physical connection from the peripheral device 100 to the switch 110, and from there to the host 120 in order to access memory 145. For purposes of illustration in FIG. 2A, the DMA traffic 115 is shown superimposed on the physical connection between the peripheral device 100 and the switch 110, and in particular the information provided by a single request packet 150 issued by the peripheral device 100 in order to seek to access memory is shown, along with associated metadata. The packet 150 includes control information in a field 155, in this example identifying that the request packet is seeking to perform a memory write operation. A virtual address 165 is also provided within the packet, and in addition the RID value is also provided within the packet within field 160 in this example.

Further, in this example a prefix 170 is associated with the packet 150, that provides an Extended Function ID (EFID). In particular, rather than seeking to capture the function related information within the RID 160, in this example the separate prefix 170 is used for this purpose, and is referred to by the SMMU 130 in order to identify the virtual machine that has been allocated to the virtual function issuing the request packet, hence enabling the appropriate second stage address translation to be performed. It should be noted that this EFID prefix 170 is only meaningful to the peripheral device 100 and to the host SMMU 130, meaning that intermediate components such as the switch 110 do not need to be altered in order to accommodate the transfer of packets that include this additional EFID prefix 170.

As also shown in FIG. 2A, a further prefix 175 is provided to identify a Process Address Space ID (PASID), which is a PCIe-defined value that is allocated and managed by the operating system of the relevant virtual machine. This information can be used by the SMMU 130 to control the first stage address translation, and in particular to perform a first stage address translation that is controlled by the particular virtual machine allocated to the virtual function that has issued the request packet 150, with the address translation being dependent on the process to which the request packet relates.

It should be noted that, in accordance with the techniques described herein, the RID field 160 forms a source indication used to control routing of an associated response packet over the packet network to the peripheral device 100, and hence is used for example in association with any acknowledgement to be provided to the peripheral device, and in the event of a read access, for example, in association with a packet providing the read data back to the peripheral device. The EFID 170 and PASID 175 then form two further, distinct, fields, separate to the RID field 160. The PASID 175 provides a process indication used by the SMMU 130 to control the first stage address translation for the specified virtual address 165, whilst the EFID 170 provides a virtual machine indication used by the SMMU 130 to control the second stage address translation for the specified address 165.

By providing these three pieces of information as distinct fields, this provides a great deal of flexibility, alleviating the scalability issue discussed earlier by enabling decoupling of the routing information within the RID 160 from the second stage address translation control information in the EFID 170. It also provides clear separation between the information provided for the first stage address translation and the information provided for the second stage address translation, by providing separate prefixes for the PASID 175 and the EFID 170, hence assisting in ensuring isolation between the address spaces allocated to the different virtual machines under hypervisor control.

FIG. 2B illustrates how the host SMMU 130 uses the above mentioned information within the packet and associated metadata to control the two stage address translation process. However, firstly reference will be made to FIG. 2C, which schematically illustrates the two stage address translation process. The virtual address 200, i.e. the address provided within the address field 165 of the packet 150 shown in FIG. 2A, is subjected by the SMMU 130 to a first stage address translation process in order to generate an intermediate physical address 205. The way in which the virtual address is translated to form the intermediate physical address is controlled by the operating system running the process for which the peripheral device is performing a task, and hence the first stage address translation can be seen as being operating system/VM controlled. In particular, for any VM, the way in which the virtual address is translated can be made dependent on the process to which the request transfer relates.

As also shown in FIG. 2A, the intermediate physical address 205 is then subjected to a second stage address translation in order to form the final physical address 210 within the memory 145. This is hypervisor controlled, and hence can be made dependent on the VM that is executing the process associated with the request packet.

Returning to FIG. 2B, it can be seen that the virtual address 165 is provided to a first stage address translation element 134 within the host MMU 130, which can perform the virtual address to intermediate physical address translation in dependence on a first stage translation configuration table or tables. To determine the appropriate translation to perform during the first stage, the PASID 175 is referred to. In particular, the job of the SMMU 130 is to seek to map (associate) individual device context to VMs, and for each device there is no prescribed usage or structure for this mapping, instead this mapping depending on software choice and/or usage. Hence, what the value of the PASID actually means may be different for different devices. For example, PASID values 0 to 3 might be associated with different processes when used from a device having a RID value of 123, compared to the processes associated with PASID values 0 to 3 from a device having a RID value of 456. In such a scenario, the operating system may in software have knowledge to map between a particular process and the PASID value that should be used in communications with a given device in relation to that particular process.

Accordingly, the RID value 160 can be input to a per-device configuration block 132 in order to produce information that is also used to control the first stage address translation, in particular to control how the PASID value is interpreted in dependence on the specified RID value, that RID value identifying the peripheral device issuing the request.

This can be useful for a variety of reasons. For example, it may be that different peripheral devices use different size PASID values. Taking a specific illustrative example, if one piece of endpoint hardware (peripheral device) supports only, say, 8 bits of PASID, whereas another endpoint device supports 20 bits of PASID, it may be that the host device wants to use both endpoints in association with one process, but they cannot both use a PASID value of 0x3000. Hence, the per-device configuration block 132 can be used to determine, on a RID-by-RID basis, how the PASID value should be interpreted when performing the first stage address translation, in particular to determine which process the PASID value is identifying, and hence choose the appropriate first stage address translation to use in dependence on that identified process.

It should be noted that if hardware resources allow, for example if all of the endpoint devices support 20 bits of PASID, it is possible for the operating system to treat PASID as a global entity that is not dependent on the RID value, and hence for a process to use the same PASID for any endpoint device. However, as such a possibility is not guaranteed, the first stage address translation space as selected using a given PASID value might need to be specific to the particular endpoint device in question, as indicated by the RID value, and hence the IOMMU will typically have to be capable of selecting different sets of first stage translations for each RID value (even if in some cases they might all in practice point to a shared set of first stage translations, with each endpoint using the same common meaning for PASID values). It is for this reason as shown in FIG. 1 that the RID value is therefore used to select a device-specific list of first stage translations indexed by PASID in hardware, even if sometimes software might choose to point to one common list of first stage translations indexed by PASID.

An analogous approach can also be performed in relation to the EFID value 170 used to provide a virtual machine indication for the virtual machine executing the process associated with the request packet. Hence, again, if desired the RID value 160 can be used to identify a device-specific list of second stage translations indexed by the EFID value, as indicated by the dotted line from the per-device configuration block 132 to the second stage translation block 136. The second stage address translation block can then determine the appropriate translation to perform based on the provided EFID value 170.

Alternatively, it may be that a per-device configuration is not needed for EFID values, and accordingly the per-device configuration block 132 does not need to be referred to when considering the EFID values. Instead, a common set of second stage translations indexed by EFID can be used, with that common set for example being identified in any suitable manner, for example with reference to global configuration information 138 as shown in FIG. 2B.

As shown in FIG. 2B, the intermediate physical address determined from the virtual address using the first stage translation components 134 is forwarded to the second stage translation components 136 which convert the intermediate physical address into a final physical address output as the transaction address 180 to the interconnect 140 for accessing memory 145.

Hence, it can be seen that the PASID value and EFID value provide a hierarchy. The PASID value is used to select between first stage translations, whereas the EFID value is used to select between second stage translations. The PASID can hence be seen as VM-local, creating a hierarchy. In particular, the VM second stage translation is selected based on the EFID value, and then the PASID is used to select the first stage translation within that VM. Such a hierarchy is useful for security reasons, since if an entity can influence the PASID value then it may have access to different address spaces within a VM, but the effect is contained to a particular VM, and has no effect on the second stage translation.

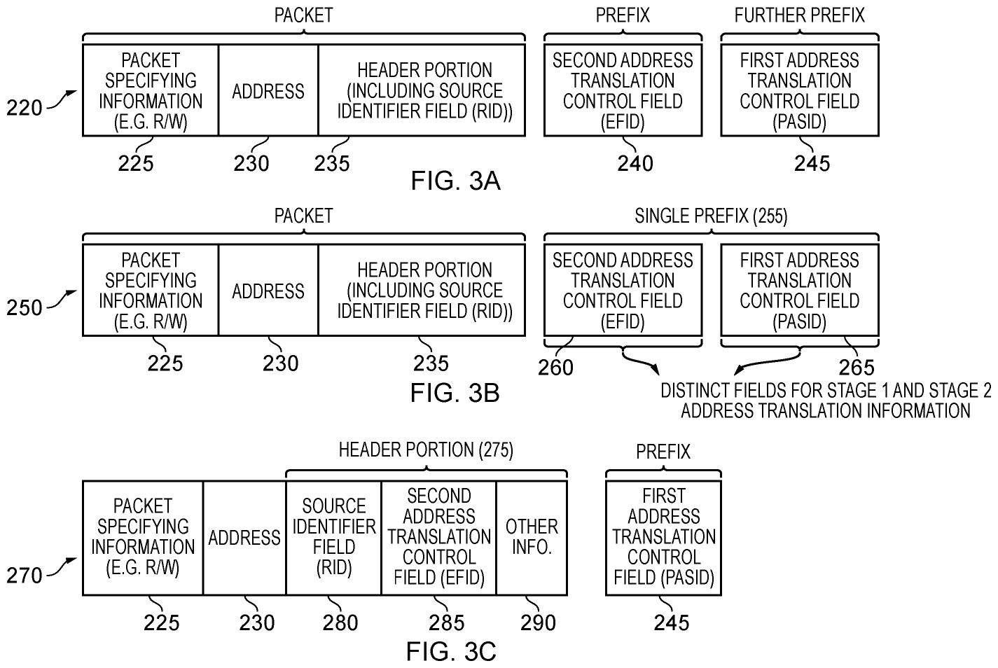

FIGS. 3A to 3C illustrate different example formats of packet and associated metadata that may be used in different example implementations. FIG. 3A illustrates the format discussed earlier with reference to FIG. 2A, and hence shows a packet and associated metadata 220, in which a first prefix 240 provides the second address translation control field (EFID) and a separate further prefix 245 provides the first address translation control field (PASID). As illustrated in FIG. 3A, the packet itself includes packet specifying information in field 225, for example to distinguish between read and write operations, an address field 230 to provide the address (for example a virtual address, but in some instances this could be an intermediate physical address, or even a physical address), and a header field 235 that can include various information, including the source identifier field (RID).

FIG. 3B illustrates an alternative variant of packet and associated metadata 250. In this example, the packet is the same as discussed earlier in FIG. 3A, but the first and second address translation control fields have been provided within a single prefix 255. Hence, the second address translation control field 260 and the first address translation control field 265 are provided as separate distinct fields within a single prefix 255. Since the fields are kept distinct and separate, this still allows suitable separation between the first stage address translation control information and the second stage address translation control information, assisting in maintaining security by isolating the address spaces of different virtual machines from each other under hypervisor control.

FIG. 3C illustrates a yet further alternative variant of packet and associated metadata 270. In this example, the packet specifying information field 225 and address field 230 are the same as in the other examples. However, the header portion 275 is arranged to include not only the source identifier field (RID) 280 and any other suitable information 290 that may also normally be included within the header portion, but also includes the second address translation control field 285 providing the EFID value. This can be a suitable approach in situations where the header has sufficient space to accommodate the EFID information.

As discussed earlier, the RID typically includes a bus portion and a function portion, and in an example of a 16 bit RID field, bits 15 to 8 may identify the bus, whilst bits 7 to 0 can be used to identify different functions. In accordance with the techniques described herein, the function information can be decoupled from the RID, so that the RID is effectively used solely for routing of response packets, whilst the function information is captured within the EFID value.

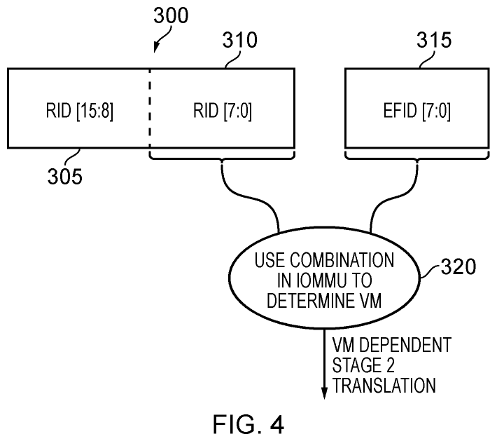

However, FIG. 4 illustrates a further variant where the separate EFID field is still provided, but a certain subset of bits from the RID value are also used to determine the virtual machine, and hence identify the required second stage address translation to perform. As shown in FIG. 4, the RID value 300 includes a first portion 305 and a second portion 310, whilst the separate EFID field 315 then provides a certain number of EFID bits. In this example, the first portion 305 of the RID value is used to control routing, by effectively identifying the bus associated with the endpoint device. Bits 7 to 0 may then be unused, but in the example shown in FIG. 4 those bits can be repurposed to provide additional information that can be used, in combination with the EFID value 315, to determine the VM, as indicated by the bubble 320 in FIG. 4. By using the lower order bits of the RID, in combination with the EFID, a suitable VM dependent second stage address translation can then be identified. Such an approach would for example allow the size of the EFID field to potentially be reduced, since some of the bits required to specify the virtual machine are provided in the low order, unused, bits of the RID value 300. Alternatively, such an approach would allow the effective size of the virtual machine identifier to be increased, for example by retaining a 16 bit EFID value and extending it by another 8 bits by also using the low order, unused, bits of the RID value 300.

As a yet further alternative example, the approach of FIG. 4 may not be used, and instead the low order bits of the RID can be used as transaction tags to track outstanding requests. In particular, there can be a performance benefit by allowing one endpoint device to emit transactions with more than one different RID value, as this allows a number of outstanding requests to be in progress, and for the responses to be tracked and matched with the associated requests. Hence, in such an implementation the upper order bits of the RID value can be used to identify the bus, and the lower order bits of the RID value can be used to distinguish between different outstanding requests, by allowing different RID values to be output in association with those requests. In that example, the approach of FIG. 4 may not be used, and instead the EFID value will be used as discussed earlier with reference to FIG. 2B in order to identify the second stage address translation to perform.

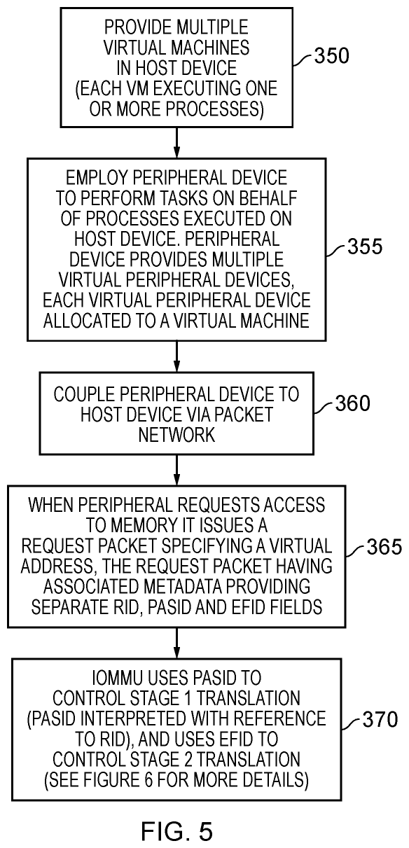

FIG. 5 is a flow diagram illustrating the technique described herein. At step 350, multiple virtual machines are provided within the host device, where each virtual machine may execute one or more processes. At step 355, one or more peripheral devices are employed to perform tasks on behalf of processes executed on the host device. At least one peripheral device may provide multiple virtual peripheral devices, with each virtual peripheral device allocated to a virtual machine.

As indicated at step 360, the peripheral device or peripheral devices are coupled to the host device via a packet network. When a peripheral device supporting multiple virtual peripheral devices requests access to memory, it can be arranged, as indicated at step 365, to issue a request packet specifying an address (which in the example shown in FIG. 5 is assumed to be a virtual address), with the request packet having associated metadata providing separate RID, PASID and EFID fields.

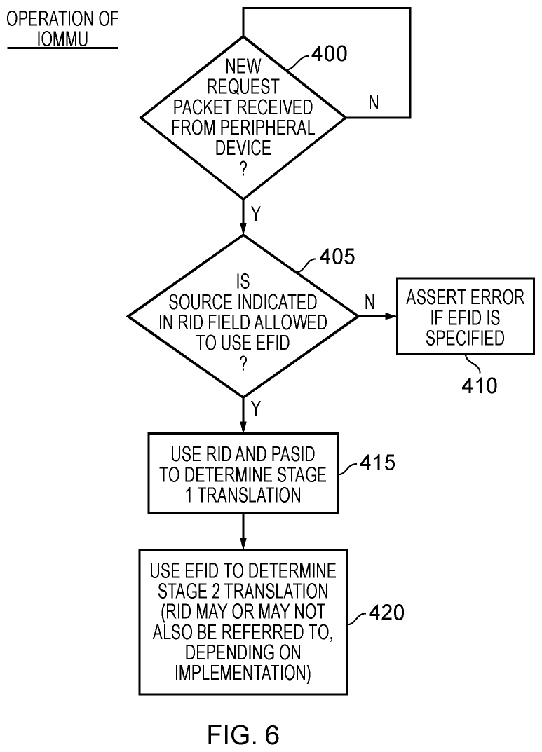

As indicated by step 370, the IOMMU then uses the PASID to control the first stage address translation, typically the PASID being interpreted with reference to the RID value. Further, as discussed earlier, the EFID field is used to control the second stage address translation, and may or may not also be interpreted with reference to the RID value. More details of this final step 370 are shown in FIG. 6.

In particular, as shown in FIG. 6, at step 400 it is determined whether a new request packet has been received from a peripheral device of the type that supports the provision of multiple virtual peripheral devices. When such a request packet is received, then it is determined at step 405 whether the source indicated in the RID field is allowed to use the EFID field. Hence, in this example, the source indication provided in the RID field can be used to perform a permission check to determine whether the peripheral device is allowed to issue request packets with the EFID prefix. If it is determined that the source endpoint device is not allowed to use the EFID field, then an error can be asserted at step 410 if the EFID prefix is specified in association with the request packet. It will be appreciated that there are various variants that can be used instead of step 410. For example, if the EFID is not present, the process may be arranged to fall back to existing behaviour, for example translating at the first stage translation based on the provided PASID value, and then using a common translation for the second stage. Alternatively, the access could be blocked if use of EFID is mandatory, and further these choices could potentially be set up on a per-device basis by software configuration.

Assuming the source indicated in the RID field is allowed to use the EFID prefix, then the process proceeds to step 415 where the RID value and PASID value are used to determine the first stage address translation, in the manner discussed earlier with reference to FIG. 2B.

Then, at step 420 the EFID value is used to determine the second stage address translation, again in the manner as discussed earlier with reference to FIG. 2B. As noted earlier, the RID value may or may not also be referred to during this process, depending on implementation.

Whilst in the examples described above a packet network has been considered, the techniques described herein can be employed in any suitable communication network, and hence for example could be used within an on-chip interconnect in some implementations. For instance, a System-on-chip (SoC) may have an on-chip/integrated peripheral device provided thereon, which can communicate with the host's processing circuitry via an on-chip interconnect. By way of specific example, considering again PCIe technology, rather than external peripheral devices 30, 90 such as shown in FIG. 1, the host system may incorporate a PCIe Root Complex integrated endpoint which appears to software as being a PCIe device (it has for instance the same register programming interface as would an external PCIe device). Such an integrated endpoint device could for example issue DMA requests without using a PCIe network, and instead could for example use an on-chip proprietary communication protocol such as Arm Limited's AMBA CHI or AMBA AXI protocols. The request transfers issued by such a device could still adopt the format discussed herein, and thus have associated metadata that provides as separate fields a source identifier field, a first address translation control field and a second address translation control field.

In accordance with the techniques described herein, it will be appreciated that a mechanism has been described that allows higher scalability to be achieved for techniques such as I/O virtualisation, by extending existing request transfer formats with an additional identifier. This would allow, for example, a larger number of virtual device contexts to be employed in systems where a large VM host may be provided, for example in a data centre.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
a host device coupled to a memory system and arranged to provide a plurality of virtual machines, where each virtual machine is arranged to execute one or more processes;
a peripheral device arranged to perform tasks on behalf of the processes executed on the host device, and coupled to the host device via a communication network, wherein the peripheral device is configurable as a plurality of virtual peripheral devices, where each virtual peripheral device is allocated to one of the virtual machines; and
address translation circuitry associated with the host device and arranged to perform an address translation to translate a given address into a corresponding physical address within the memory system, when the given address is a virtual address the address translation comprising a first stage address translation that is dependent on the process associated with the given address, and the address translation further comprising a second stage address translation that is dependent on the virtual machine associated with the given address;
wherein:
the peripheral device is arranged, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

2. An apparatus as claimed in claim 1, wherein the communication network is a packet network, the request transfer takes the form of a request packet, and the response transfer takes the form of a response packet.

3. An apparatus as claimed in claim 2, wherein:
the second address translation control field is provided as an external item of metadata provided separately to the request packet but associated with the request packet.

4. An apparatus as claimed in claim 3, wherein:
the first address translation control field is provided as a further external item of metadata provided separately to the request packet but associated with the request packet, the further external item of metadata being distinct from the external item of metadata providing the second address translation control field.

5. An apparatus as claimed in claim 3, wherein the first and second address translation control fields are provided as distinct fields within the external item of metadata.

6. An apparatus as claimed in claim 2, wherein the second address translation control field is provided within a header portion of the request packet.

7. An apparatus as claimed in claim 1, wherein the virtual machine indication takes the form of a virtual peripheral device indication indicating the virtual peripheral device issuing the request transfer, and the address translation circuitry is arranged to determine, with reference to the virtual peripheral device indication, the virtual machine to which the virtual peripheral device issuing the request transfer is allocated.

8. An apparatus as claimed in claim 1, wherein for each request transfer issued by the peripheral device, the peripheral device is arranged to use a same source indication value to form the source indication used to control routing of the associated response transfer over the communication network to the peripheral device.

9. An apparatus as claimed in claim 1, wherein the peripheral device has a range of source indication values, any one of which is useable to control routing of response transfers over the communication network to the peripheral device, and for each request transfer issued by the peripheral device, the peripheral device is arranged to select a source indication value from the range to be used as the source indication for that request transfer.

10. An apparatus as claimed in claim 9, wherein the peripheral device is arranged to track correspondence between outstanding request transfers and their associated response transfers though use of different source indication values for different request transfers.

11. An apparatus as claimed in claim 1, wherein the address translation circuitry is arranged to determine the virtual machine associated with the virtual peripheral device issuing the request transfer directly from the virtual machine indication provided by the second address translation control field.

12. An apparatus as claimed in claim 11, wherein the virtual machine indication specifies a virtual machine number that identifies the virtual machine to the address translation circuitry.

13. An apparatus as claimed in claim 1, wherein the address translation circuitry is arranged to determine the virtual machine associated with the virtual peripheral device issuing the request transfer with reference to both the virtual machine indication provided by the second address translation control field and a source indication value forming the source indication.

14. An apparatus as claimed in claim 13, wherein the address translation circuitry is arranged to employ a subset of values of the source indication value, in combination with virtual machine indication, to determine the virtual machine associated with the virtual peripheral device issuing the request transfer.

15. An apparatus as claimed in claim 1, wherein the address translation circuitry is arranged to reference the source indication to perform a permission check to determine whether the peripheral device is allowed to issue request transfers with the second address translation control field associated therewith.

16. An apparatus as claimed in claim 2, wherein the packet network is a Peripheral Component Interconnect Express (PCIe) network, and the peripheral device is an endpoint device within the PCIe network.

17. An apparatus as claimed in claim 16, wherein the peripheral device is a Single Root I/O Virtualisation (SR-IOV) device, and the virtual peripheral devices are virtual functions.

18. (canceled)

19. (canceled)

20. A method of handling request transfers in a communication network, comprising:
providing a plurality of virtual machines within a host device coupled to a memory system, where each virtual machine is arranged to execute one or more processes;
employing a peripheral device to perform tasks on behalf of the processes executed on the host device, wherein the peripheral device is configurable as a plurality of virtual peripheral devices, where each virtual peripheral device is allocated to one of the virtual machines;
coupling the peripheral device to the host device via the communication network;
employing address translation circuitry associated with the host device to perform an address translation to translate a given address into a corresponding physical address within the memory system, when the given address is a virtual address the address translation comprising a first stage address translation that is dependent on the process associated with the given address, and the address translation further comprising a second stage address translation that is dependent on the virtual machine associated with the given address; and
causing the peripheral device, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

21. A host device comprising:
a processing element arranged to provide a plurality of virtual machines, where each virtual machine is arranged to execute one or more processes;
a bridging component to communicate, via a communication network, with a peripheral device arranged to perform tasks on behalf of the processes executed on the host device, wherein the peripheral device is configurable as a plurality of virtual peripheral devices, where each virtual peripheral device is allocated to one of the virtual machines; and
address translation circuitry arranged to perform an address translation to translate a given address into a corresponding physical address within a memory system accessible via the host device, when the given address is a virtual address the address translation comprising a first stage address translation that is dependent on the process associated with the given address, and the address translation further comprising a second stage address translation that is dependent on the virtual machine associated with the given address;
wherein:
the address translation circuitry is arranged to receive a request transfer via the bridging component from the peripheral device when the peripheral device is seeking to access the memory system, the request transfer having a specified address and having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by the address translation circuitry to control any first stage address translation required for the specified address, and the second address translation control field provides a virtual machine indication used by the address translation circuitry to control any second stage address translation required for the specified address.

22. A peripheral device comprising:
an interface to a communication network via which the peripheral device is arranged to communicate with a host device that is coupled to a memory system, the host device providing a plurality of virtual machines, where each virtual machine is arranged to execute one or more processes; and
circuitry to perform tasks on behalf of the processes executed on the host device, wherein the circuitry of the peripheral device is configurable to provide a plurality of virtual peripheral devices, where each virtual peripheral device is allocated to one of the virtual machines;
wherein:
the peripheral device is arranged, when seeking to access the memory system, to issue a request transfer with a specified address, the request transfer having associated metadata that provides as separate fields a source identifier field, a first address translation control field and a second address translation control field, wherein the source identifier field provides a source indication used to control routing of an associated response transfer over the communication network to the peripheral device, the first address translation control field provides a process indication used by address translation circuitry of the host device to control any first stage address translation required for the specified address when the specified address is a virtual address, the first stage address translation being dependent on the process associated with the specified address, and the second address translation control field provides a virtual machine indication used by the address translation circuitry to control any second stage address translation required for the specified address, the second stage address translation being dependent on the virtual machine associated with the specified address.
